(19) United States
(12) Patent Application Publication
(10) Pub. No.: US 2006/0187874 A1
(43) Pub. Date: Aug. 24, 2006

(54) Method and apparatus for supporting data flow control in a wireless mesh network

(75) Inventor: Maged M. Zaki, Pierrefonds (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/234,755

(22) Filed: Sep. 23, 2005

Related U.S. Application Data
(60) Provisional application No. 60/656,038, filed on Feb. 24, 2005.

(51) Int. Cl. H04Q 7/00

(52) U.S. Cl. 370/328

(57) ABSTRACT

A method and apparatus for supporting data flow control in a wireless mesh network by reporting to a source mesh point (MP) in a particular path the allowed data rate that each MP in the path may support. The source MP sends, over the path, a data packet destined which includes a flow identification (ID) field and an available data rate field to a destination MP. An acknowledgement (ACK) packet including the same fields is sent in response to the data packet. The source MP adjusts a data rate in accordance with the available data rate field in the ACK packet. Alternatively, a congestion indication field may be used instead of the available data rate field to indicate that congestion exists on the path. Additionally, a quality of service (QoS) field indicating QoS parameters for the data flow may be included in the data and ACK packets.

### CROSS REFERENCE TO RELATED APPLICATION

This application claims the benefit of U.S. provisional application No. 60/656,038 filed Feb. 24, 2005, which is incorporated by reference as if fully set forth.

### FIELD OF INVENTION

The present invention is related to wireless communication systems. More particularly, the present invention is related to a method and apparatus for supporting data flow control in a wireless mesh network which includes a plurality of mesh points (MPs).

### BACKGROUND

A mesh wireless local area network (WLAN) is an IEEE 802.11-based wireless distribution system (WDS) comprising a plurality of MPs interconnected via IEEE 802.11 links. Each MP on the mesh network receives and transmits its own traffic, while acting as a router for other MPs. Each MP has capabilities to automatically configure an efficient network and to adjust when a particular MP becomes overloaded or becomes unavailable. The advantages of mesh networks include ease of setup, self-configuring, self-healing, reliability, or the like.

Flow control dynamically adjusts the flow of data from one node to another in the network to ensure that every receiving node in the traffic path can handle all of the incoming data without data overflow. Flow control algorithms have been developed for different kinds of networks, (e.g., asynchronous transfer mode (ATM), transmission control protocol (TCP)/Internet protocol (IP), or the like). However, a flow control in a wireless mesh network presents new challenges such as frequent re-routing, bandwidth fluctuation and scarcity of resources on the wireless links. IEEE 802.11 wireless medium access control (MAC) deals with point-to-point connections and does not address relaying and forwarding functionality of the mesh network.

### SUMMARY

The present invention provides a method and apparatus for supporting data flow control in a wireless mesh network by reporting to a source MP in a particular path the allowed data rate that each MP in the path may support. The source MP sends, over the path, a data packet which includes a flow identification (ID) field and an available data rate field destined to a destination MP. An acknowledgement (ACK) packet including the same fields is sent in response to the data packet. The source MP adjusts a data rate in accordance with the available data rate field in the ACK packet.

Alternatively, a congestion indication field may be used instead of the available data rate field to indicate that congestion exists on the path.

Additionally, a quality of service (QoS) field indicating QoS parameters for the data flow may be included in the data and ACK packets.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a mesh network in which the present invention is implemented;

FIG. 2 shows a prior art data packet with a MAC header that does not support flow control;

FIG. 3 shows a data packet with a MAC header which supports explicit rate-based flow control in accordance with the present invention;

FIG. 4 shows a prior art ACK packet with a MAC header that does not support flow control;

FIG. 5 shows an ACK packet with a MAC header which supports explicit rate-based flow control in accordance with the present invention;

FIG. 6 is an exemplary signaling diagram of a process for supporting a data packet flow control using an end-to-end ACK mechanism in accordance with the present invention.

FIG. 7 shows a data packet with a MAC header which supports explicit rate-based flow control based on QoS in accordance with the present invention;

FIGS. 8, 9A, 9B and 9C are exemplary signaling diagrams of a process for supporting a data packet flow control by using a “hop-by-hop” ACK mechanism in accordance with the present invention;

FIG. 10 shows a prior art request-to-send (RTS) packet with a MAC header that does not support flow control;

FIG. 11 shows a prior art mesh RTS packet with a MAC header that does not support flow control;

FIG. 12 shows an RTS packet with a MAC header which supports flow control in accordance with the present invention;

FIG. 13 shows a prior art clear-to-send (CTS) packet with a MAC header that does not support flow control;

FIG. 14 shows a prior art mesh CTS packet with a MAC header that does not support flow control;

FIG. 15 shows a CTS packet with a MAC header which supports flow control in accordance with the present invention;

FIG. 16 shows a data packet with a MAC header which uses a congestion indication to support flow control;

FIG. 17 shows an ACK packet with a MAC header which uses a congestion indication to support flow control; and

FIG. 18 is an exemplary block diagram of an MP, used in the mesh network of FIG. 1, which supports flow control in accordance with the present invention.

### DETAILED DESCRIPTION OF THE PREFERRED EMBODIMENTS

Hereafter, the terminology “MP” includes but is not limited to a Node-B, a base station, a site controller, an access point (AP), a wireless transmit/receive unit (WTRU), a transceiver, a user equipment (UE), a mobile station (STA), a fixed or mobile subscriber unit, a pager or any other type of interfacing device in a wireless environment.

The features of the present invention may be incorporated into an integrated circuit (IC) or be configured in a circuit comprising a multitude of interconnecting components.

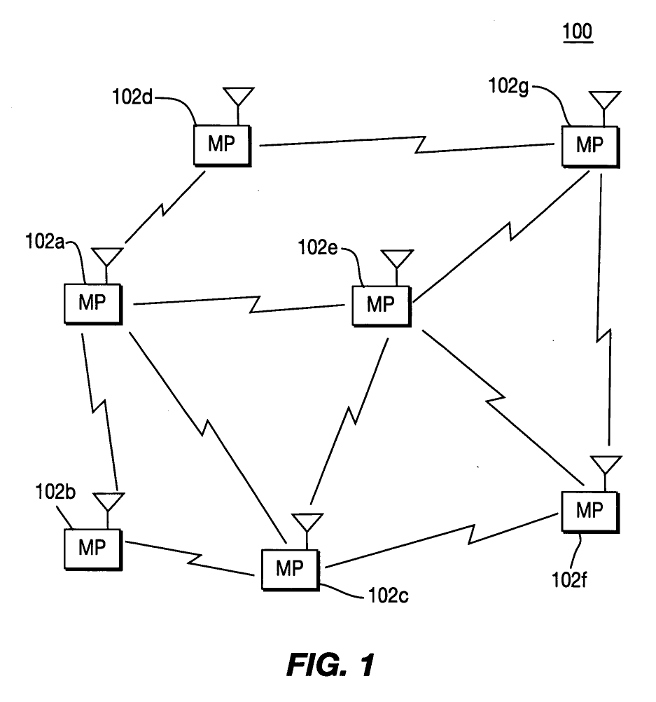

FIG. 1 shows a mesh network 100 in which the present invention is implemented. The mesh network 100 comprises a plurality of MPs 102a-102g. Each MP 102 is connected to one or more neighboring MPs 102 and receives and transmits its own traffic while acting as a router for other MPs 102. A data packet sent by a source MP 102 is routed through one or more hops to a destination MP 102. For example, a data packet sent by MP 102a may be routed to MP 102g through MP 102e. Each MP 102 determines the available bandwidth in the wireless environment and signals this information to the source MP 102 in a timely manner. In the foregoing example, MPs 102e and 102g may send a message to the MP 102a notifying the MP 102a of a data rate for the data flow available through the path.

In accordance with one embodiment of the present invention, when a source MP 102 sends a data packet, (via zero or more intermediate MPs 102), to a destination MP 102, the destination MP 102 sends back an ACK packet notifying the source MP 102 of the appropriate data rate. Each MP 102 in the path of the data packet to the destination MP 102 determines available data rate and updates the available data rate field included in the MAC header of the data packet before forwarding the data packet to a next MP 102. The destination MP 102 recognizes the available data rate, which is updated by all MPs 102 in the path and sends back an ACK packet with available data rate information to the source MP 102.

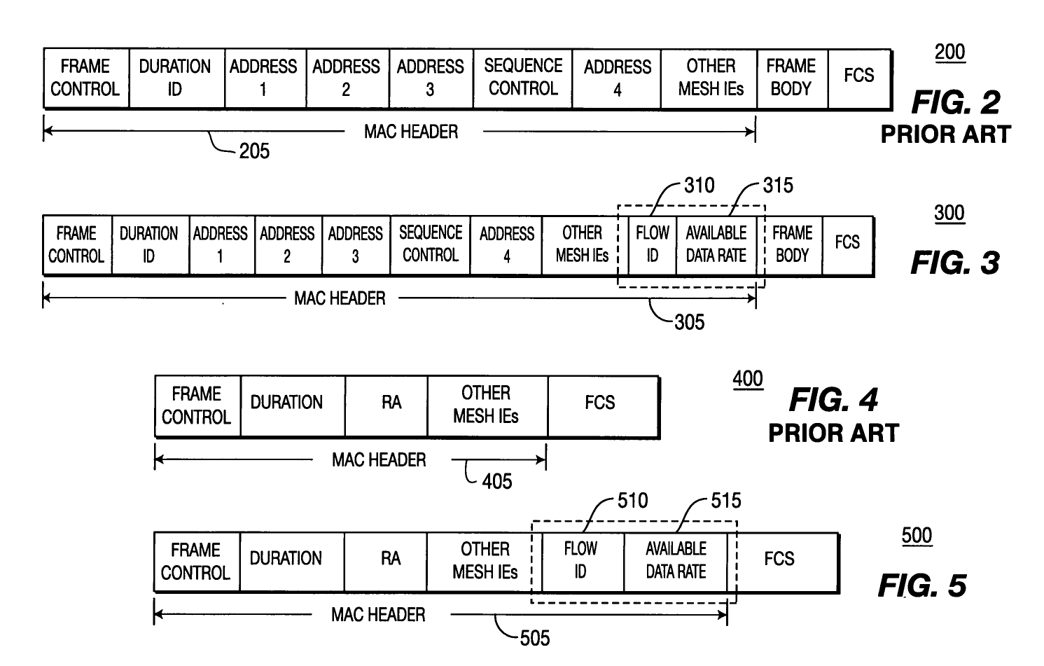

FIG. 2 shows a prior art data packet 200 with a MAC header 205 that does not support flow control.

FIG. 3 shows a data packet 300 with a MAC header 305 which supports explicit rate-based flow control in accordance with the present invention. A flow ID field 310 and an available data rate field 315 have been added to the MAC header 305 of the data packet 300. The flow ID field 310 in the data packet 300 identifies a current data packet flow under consideration. The available data rate field 315 in the data packet 300 indicates a requested data rate, (i.e., bandwidth), by the source MP 102 or an available data rate that each MP 102 on a particular path may provide.

FIG. 4 shows a prior art ACK packet 400 with a MAC header 405 that does not support flow control.

FIG. 5 shows an ACK packet 500 with a MAC header 505 which supports explicit rate-based flow control in accordance with the present invention. A flow ID field 510 and an available data rate field 515 have been added to the MAC header 505 of the ACK packet 500. The flow ID field 510 in the ACK packet 500 identifies a current data packet flow under consideration. The available data rate field 515 in the data packet 500 indicates an available data rate that the source MP 102 may use for transmitting the data packet flow identified by the flow ID field 510.

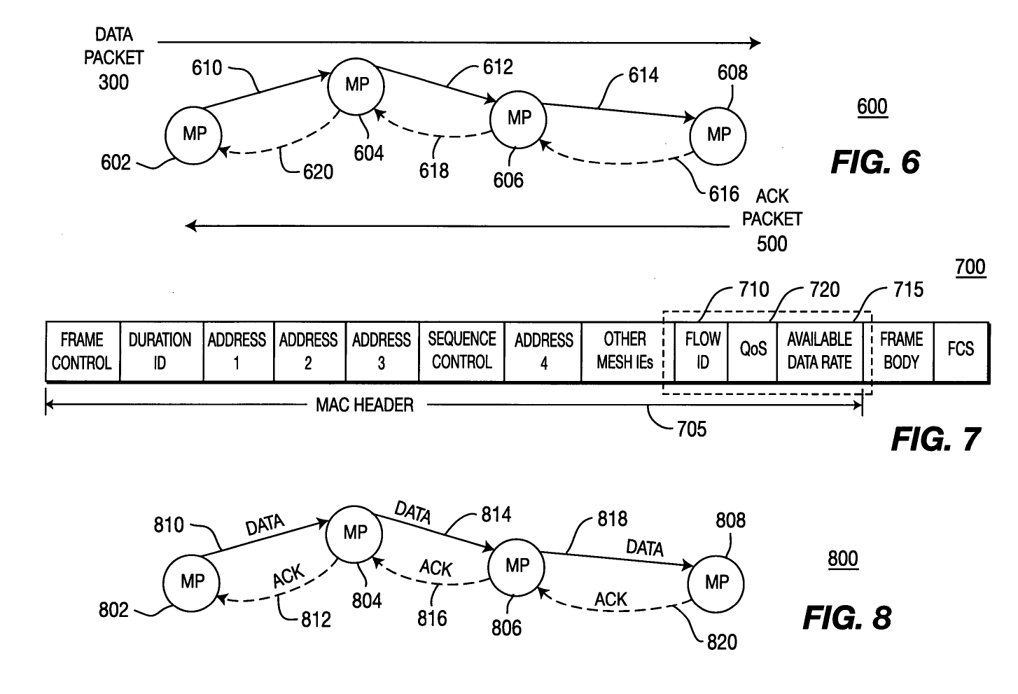

FIG. 6 is an exemplary signaling diagram of a process 600 for supporting a data packet flow control using an end-to-end ACK mechanism in accordance with the present invention. Two intermediate MPs 604,606 are depicted in FIG. 6 as an example, but there may be more or less than two intermediate MPs in the path to the destination MP 608. A source MP 602 sends a data packet 300 to the intermediate MP 604 (step 610). The intermediate MP 604 forwards the data packet 300 to the next intermediate MP 606 (step 612), which in turn forwards the data packet 300 to the destination MP 608 (step 614).

When the intermediate MP 604 receives the data packet 300, the MP 604 reads a value in the available data rate field 315 of the data packet 300, (which is originally set to a value for the requested data rate by the source MP 602), and checks if the data rate in the available data rate field 315 can be supported by MP 604. If the data rate can be supported, the intermediate MP 604 forwards the data packet 300 to the next intermediate MP 606 without changing the available data rate field 315. If the intermediate MP 604 cannot support the data rate in the available data rate field 315, the intermediate MP 604 updates the available data rate field 315 with an available data rate at the intermediate MP 604.

The same procedure is repeated at each intermediate MP 604, 606 on the path to the destination MP 608. Each MP updates the available data rate field 315 with an available data rate that each MP can support. The intermediate MPs 604,606 decide on the available data rate based on either channel occupancy measurements or buffer occupancy measurements.

The destination MP 608 reads the available data rate parameter, (i.e., the minimum available data rate written in the available data rate field 315 by all of the intermediate MPs 604,606 on the path), and sends an end-to-end ACK packet 500 with the available data rate information in the available data rate field 515 to the source MP 602 (steps 616, 618, 620). The ACK packet 500 can be transmitted through the same path back to the source MP 602 as shown in FIG. 6 or it may take a different path. When the source MP 602 receives the ACK packet 500, the source MP 602 reads the value in the available data rate field 515 in the ACK packet 500 and adjusts its data rate accordingly.

Optionally, the MPs 602-608 may consider QoS requirements for each access class in determining an available data rate for the traffic flow. FIG. 7 shows a data packet 700 with a MAC header 705 which supports explicit rate-based flow control in accordance with the present invention. The MAC header 705 includes a flow ID field 710, an available data rate field 715 and a QoS field 720. The QoS field 720 identifies the access class of the data flow or other QoS parameters. QoS parameters may include delay requirements, bandwidth requirements, or the like. Typically, these parameters will not change except in some cases such as remaining life time of the packets in order to determine how much delay the packet can tolerate before it reaches the destination. The MPs may reduce the data rate for data flows with a lower priority access class to accommodate higher access class flows. A data flow with a specific priority access may identify a range of data rates that it requires. The MP may attempt to accommodate each data flow within this range. If it has more resources, the MP may provide more bandwidth for the data flows.

In accordance with another embodiment, the available data rate is determined in each MP and this information is signaled to the source MP by using a “hop-by-hop” ACK mechanism. FIG. 8 is an exemplary signaling diagram of a process 800 for supporting a data packet flow control by using a “hop-by-hop” ACK mechanism. Two intermediate MPs 804, 806 are depicted in FIG. 8 as an example, but there may be more or less than two intermediate MPs 804, 806 in the path to the destination MP 808. In accordance with this embodiment, every time an MP receives a data packet or an ACK packet, the MP updates its database with the new available data rate and replies with this updated available data rate in the next round. If the bottleneck is N MPs further away from the source MP 802, it takes the source MP 802 N roundtrip delays until the source MP 802 updates itself with the correct available data rate.

Referring to FIG. 8, the source MP 802 sends a data packet to an intermediate MP 804 (step 810). The intermediate MP 804 sends an ACK packet to the source MP 802 (step 812) before forwarding the data packet to next intermediate MP 806 (step 814). When the intermediate MP 804 receives the data packet, the intermediate MP 804 reads a value in the available data rate field of the data packet, (which is originally set to a value for a requested data rate by the source MP 802), and checks if the rate in the available data rate field can be supported by intermediate MP 804. If the rate can be supported, the intermediate MP 804 sends an ACK packet to source MP 802 and forwards the data packet to a next intermediate MP 806 with the same value. If the intermediate MP 804 cannot support the requested data rate, intermediate MP 804 sends the ACK packet to MP 802, and also forwards the data packet to the MP 806, with an updated value in the available data rate field with an available data rate at the intermediate MP 804.

The same procedure is repeated at the next intermediate MP 806 on the path to the destination MP 808. The intermediate MP 806 receives the data packet and sends an ACK packet to MP 804 (step 816) and forwards the data packet to a destination MP 808 (step 818). Each MP updates the available data rate field with an available data rate that each MP can support.

The destination MP 808 reads the available data rate parameter, (i.e., an available bandwidth written by the intermediate MP 806), and then sends an ACK packet to the intermediate MP 806 (step 820). When each MP 802, 804, 806 receives the ACK packets, the MPs 802, 804, 806 set available data rates based on the values in the available data rate field of the ACK packet.

In accordance with this embodiment, an end-to-end ACK message is not necessary and minimal changes are required to the current IEEE 802.11 standards. This embodiment provides a slower adaptation to changes in the network conditions because of the required convergence time. The convergence time depends on how far the bottleneck MP is from the source MP.

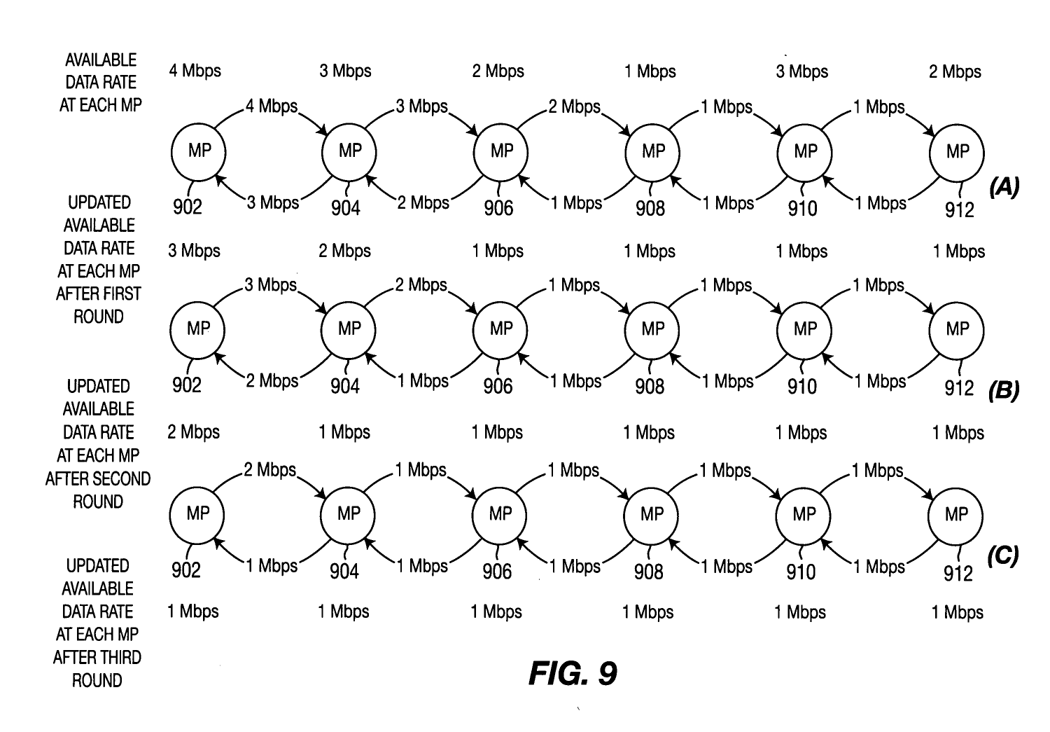

FIGS. 9A-9C are exemplary signaling diagrams of a hop-by-hop ACK mechanism which includes a plurality of MPs 902, 904, 906, 908, 910 and 912 in accordance with the present invention. In this example, the requested data rate by the source MP 902 is 4 Mbps, but not all of the MPs 904-912 can support the requested data rate. The bottleneck in this example is the fourth MP 908 which can support only 1 Mbps. As illustrated, the source MP 902 recognizes the available date rate for this flow after three roundtrips.

In the first round, which is shown in FIG. 9A, the source the MP 902 sends a data packet with a requested data rate of 4 Mbps. However, the available bandwidth at the MP 904 is only 3 Mbps. Therefore, the next MP 904 sends back an ACK packet with 3 Mbps as the available data rate. The source MP 902 updates the available data rate for this flow to 3 Mbps after receiving the ACK packet. Simultaneously, the MP 904 forwards the data packet with an updated available data rate field of 3 Mbps to the MP 906.

The available data rate at MP 906 is currently 2 Mbps. Therefore, the MP 906 sends an ACK packet to the MP 904 with an available data rate 2 Mbps. MP 904 updates the available data rate for this flow with 2 Mbps. The MP 906 sends the data packet to the MP 908 after updating the available data rate field with 2 Mbps.

The available data rate at the MP 908 is currently 1 Mbps. Therefore, the MP 908 sends an ACK packet to the MP 906 with an available data rate 1 Mbps. The MP 906 updates the available data rate for this flow with 1 Mbps. The MP 908 sends the data packet to the MP 910 after updating the available data rate field with 1 Mbps.

The available data rate at the MP 910 is currently 3 Mbps. Therefore, the MP 910 sends an ACK packet to the MP 908 with the same rate 1 Mbps. No update of the available data rate for this flow occurs at the MP 908. The MP 910 sends the data packet to a destination MP 912 with previously updated available data rate 1 Mbps and updates its available data rate for this flow to 1 Mbps.

The available data rate at the MP 912 is currently 2 Mbps. Therefore, the MP 912 sends an ACK packet to the MP 910 with the same available data rate, 1 Mbps. The destination MP 912 updates the available data for this flow to 1 Mbps. In the first round, the MPs 902, 904, 906, 910 and 912 have updated their available data rate for this flow with different values.

In the second round, which is shown in FIG. 9B, the same procedure is repeated. In the second round, the MP 902 sends a data packet to the MP 904 with an available data rate field of 3 Mbps, which is updated in the first round. The available data rate at the MP 904 is currently 2 Mbps. Therefore, the MP 904 sends an ACK packet to the MP 902 with an available data rate 2 Mbps. The MP 902 updates the available data rate for this flow with 2 Mbps. The MP 904 sends the data packet to the MP 906 after updating the available data rate field with 2 Mbps.

The available data rate at the MP 906 is currently 1 Mbps. Therefore, the MP 906 sends an ACK packet to the MP 904 with an available data rate of 1 Mbps. The MP 904 updates the available data rate for this flow with 1 Mbps. The MP 906 sends the data packet to the MP 908 after updating the available data rate field with 1 Mbps. The data packet is then forwarded to the destination MP 912 via the MPs 908, 910 while the available data rate field is not updated.

In the third round, which is shown in FIG. 9C, the MP 902 sends a data packet to the MP 904 with an available data rate field of 2 Mbps, which is updated in the second round. The available data rate at the MP 904 is currently 1 Mbps. Therefore, the MP 904 sends an ACK packet to the MP 902 with an available data rate of 1 Mbps. The MP 902 updates the available data rate for this flow with 1 Mbps. The MP 904 sends the data packet to the MP 906 after updating the available data rate field with 1 Mbps. The data packet is then forwarded to the destination MP 912 via the MPs 906, 908, 910 without updating the available data rate field. After the third round, the available data rate at the MP 902 is updated to 1 Mbps, which is a correct available data rate on the path.

In accordance with a third embodiment of the present invention, the available bandwidth in each MP is updated by using an RTS packet and a CTS packet. In this embodiment, a source MP sends an RTS packet, (or an Add Flow Request message), to a destination MP with a flow ID and a requested data rate. The RTS packet may optionally have a QoS field to indicate the required QoS. When the destination MP receives the RTS, (or an Add Flow Request frame), the destination MP checks the data rate available for this flow and if the destination MP can satisfy its minimum QoS requirements and sends back a CTS, (or an Add Flow Response frame), with an available data rate.

The RTS packet may be sent every time a new flow of data is initiated; every time the data path is being changed; periodically to update the source MP with the available bandwidth; or when the source MP wants to change the required data rate.

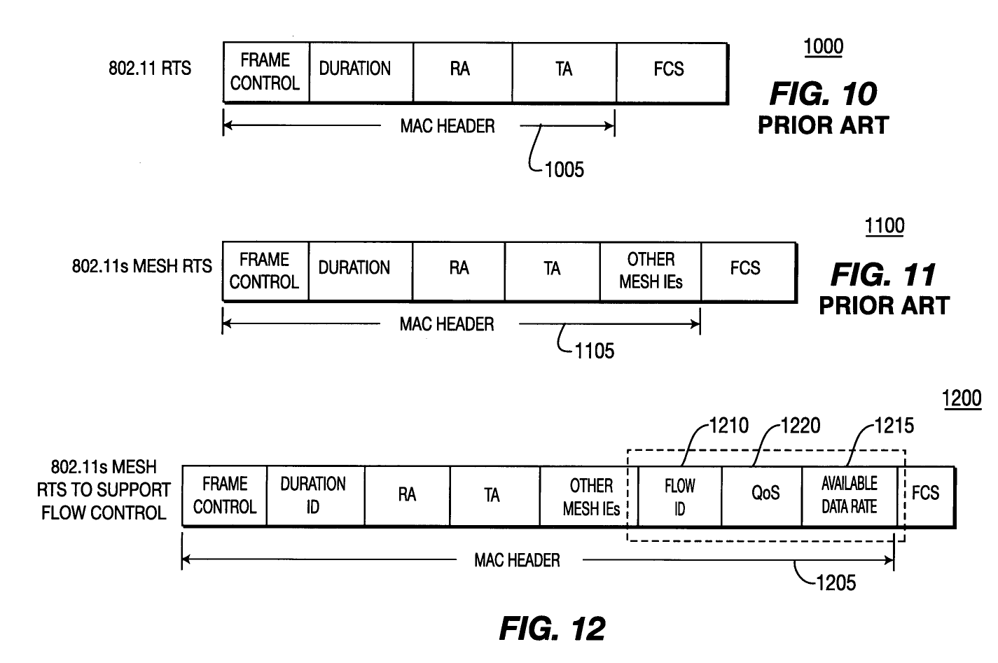

FIG. 10 shows a prior art RTS packet 1000 with a MAC header 1005 that does not support flow control.

FIG. 11 shows a prior art mesh RTS packet 1100 with a MAC header 1105 that does not support flow control.

FIG. 12 shows an RTS packet 1200 with a MAC header 1205 which supports flow control in accordance with the present invention. The RTS packet 1205 includes a flow ID field 1210, an available data rate field 1215 and a QoS field 1220 (optional) in the MAC header 1205.

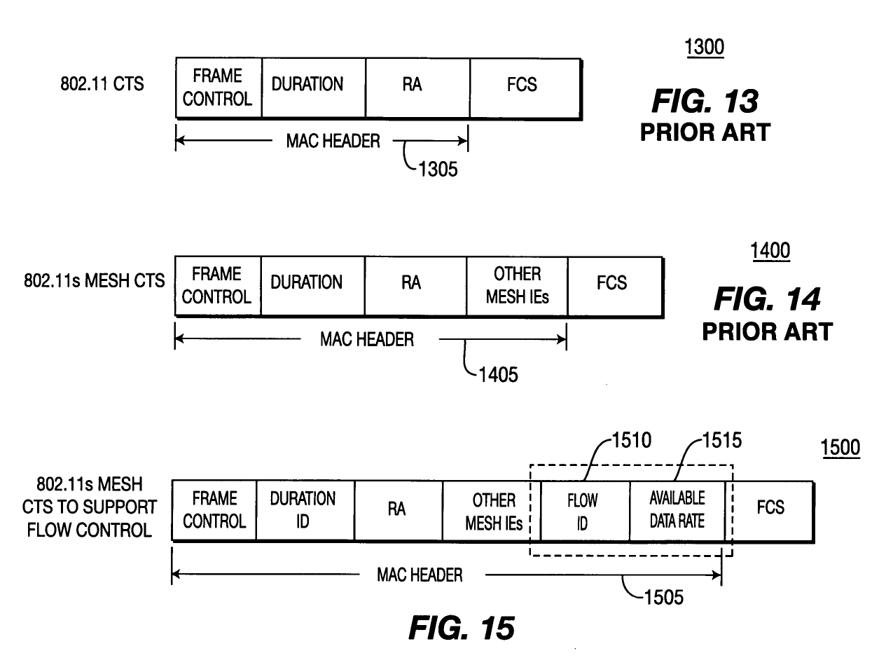

FIG. 13 shows a prior art CTS packet 1300 with a MAC header 1305 that does not support flow control.

FIG. 14 shows a prior art mesh CTS packet 1400 with a MAC header 1405 that does not support flow control.

FIG. 15 shows a CTS packet 1500 with a MAC header 1505 which supports flow control in accordance with the present invention. The MAC header includes a flow ID field 1510 and an available data rate field 1515.

Alternatively, an add flow request frame and an add flow response frame may be defined for the same purpose. The add flow response frame may have the same format or may have an extra field indicating whether the data flow can be accepted.

Instead of using an explicit rate based flow control, a congestion indication may be used for flow control in accordance with the present invention.

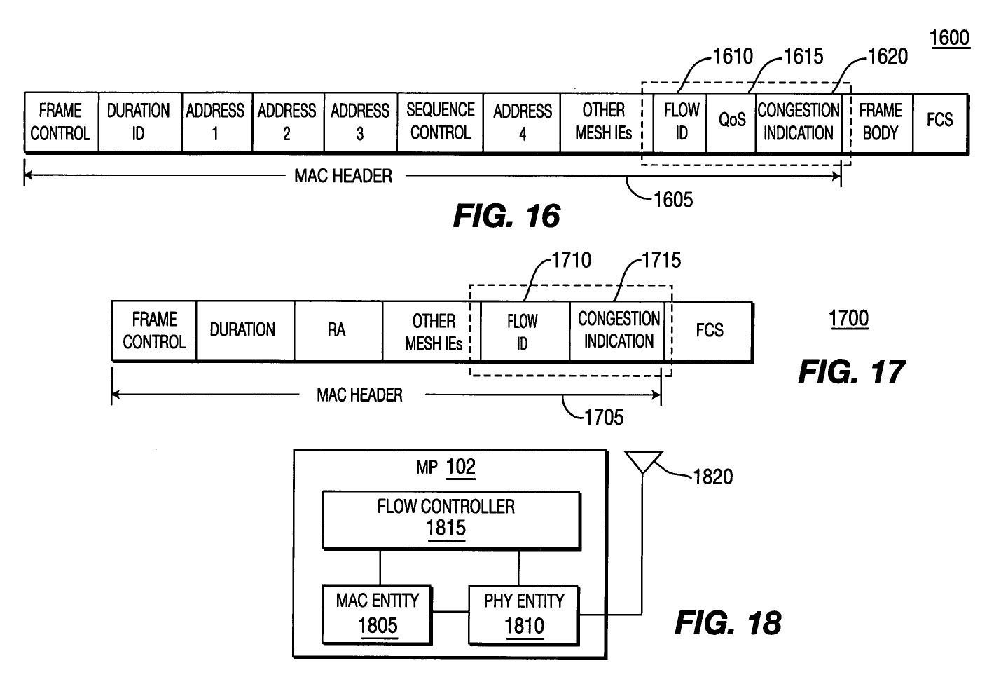

FIG. 16 shows a data packet 1600 with a MAC header 1605 which uses a congestion indication to support flow control. The MAC header 1605 includes a flow ID field 1610, a QoS field 1615 and a congestion indication field 1620 instead of an available data rate field. The congestion indication field 1620 indicates to the source MP to decrease, increase or maintain its current traffic rate. The congestion indication itself is not related to QoS. The manner in which each MP deals with the congestion indication of different data flows may be based on the access class. The congestion may be detected when the MP finds that it receives more packets than it is able to send, or continually loses packets while the radio conditions are good. The congestion indication field 1620 may be a one-bit field such that that the congestion indication field is set to “1” whenever any MP in the path starts to experience congestion. Once the congestion field is set to “1”, no other intermediate node will reset it back to zero.

FIG. 17 shows an ACK packet 1700 with a MAC header 1705 which uses a congestion indication to support flow control. The MAC header 1705 includes a flow ID field 1710 and a congestion indication field 1715.

FIG. 18 is an exemplary block diagram of an MP 102, used in the mesh network 100 of FIG. 1, which supports flow control in accordance with the present invention. The MP 102 includes a MAC entity 1805, a physical layer (PHY) entity 1810, a flow controller 1815 and an antenna 1820. The MAC entity 1805 generates data packets and ACK packets. The PHY entity 1810 transmits data packets and ACK packets generated by the MAC entity 1805 via an antenna 1820 and processes data packets and ACK packets received via the antenna 1820 from other MPs. The flow controller 1815 is configured to update the available data rate field of the MAC header of the data and ACK packets based on available data rate at the MP and, optionally, further based on QoS parameters for the data flow. If the MP 102 is a source MP, it sends a data packet to a destination MP and adjusts the data rate for the current data flow in accordance with an ACK packet received in response to the data packet.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless mesh network including a plurality of mesh points (MPs), a method of supporting data flow control in the mesh network, the method comprising:
(a) a source MP sending, over a path, a data packet destined to a destination MP, the data packet including a flow identification (ID) field and an available data rate field, the available data rate field in the data packet indicating a data rate requested by the source MP for a data flow identified by the flow ID field; and
(b) sending an acknowledgement (ACK) packet to the source MP in response to the data packet, the ACK packet including a flow ID field and an available data rate field, whereby the source MP adjusts a data rate in accordance with the available data rate field in the ACK packet.

2. The method of claim 1 wherein the path includes at least one intermediate MP between the source MP and the destination MP.

3. The method of claim 2 wherein the intermediate MP forwards the data packet to another intermediate MP or the destination MP after updating the available data rate field of the data packet based on an available data rate at the intermediate MP that forwarded the data packet.

4. The method of claim 3 wherein the ACK packet is an end-to-end packet sent from the destination MP to the source MP, and the destination MP generates the ACK packet based on the data packet with an available data rate field that is updated by an intermediate MP in the path.

5. The method of claim 4 wherein the ACK packet is sent back to the source MP via the same path through which the data packet is forwarded to the destination MP.

6. The method of claim 4 wherein the ACK packet is sent back to the source MP via a path different than the path that the data packet is forwarded to the destination MP.

7. The method of claim 3 wherein the data packet further includes a quality of service (QoS) field indicating QoS parameters for the data flow, whereby each MP on the path determines available data rate for the data flow by further considering the QoS parameters.

8. The method of claim 3 wherein each MP in the path sends the ACK packet to a preceding MP, whereby each MP updates an available data rate for the data flow based on the received data packet from the preceding MP and the ACK packet received from the next MP.

9. The method of claim 8 wherein the data packet further includes a quality of service (QoS) field indicating QoS parameters for the data flow, and each MP on the path determines an available data rate for the data flow by further considering the QoS parameters.

10. The method of claim 3 wherein the MP determines the available data rate at the MP based on at least one of a channel occupancy measurement and a buffer occupancy measurement.

11. The method of claim 1 wherein the data packet is a request-to-send (RTS) packet and the ACK packet is a clear-to-send (CTS) packet.

12. The method of claim 11 wherein the RTS packet is sent when a new data flow is initiated.

13. The method of claim 11 wherein the RTS packet is sent when the data flow is changed.

14. The method of claim 11 wherein the RTS packet is sent periodically to update the source MP with the available data rate.

15. The method of claim 11 wherein the RTS packet is sent when the source MP wants to change the data rate.

16. The method of claim 1 wherein the data packet is an add flow request packet and the ACK packet is an add flow response packet, the add flow request packet and the add flow response packet being management packets intended for supporting the flow control.

17. The method of claim 1 wherein the wireless mesh network is a mesh wireless local area network (WLAN).

18. In a wireless mesh network including a plurality of mesh points (MPs), a method of supporting data flow control in the mesh network, the method comprising:
(a) a source MP sending, over a path, a data packet destined to a destination MP, the data packet including a flow identification (ID) field and a congestion indication field, the congestion indication field in the data packet indicating that congestion exists on the path; and
(b) sending an acknowledgement (ACK) packet to the source MP in response to the data packet, the ACK packet including a flow ID field and a congestion indication field, whereby the source MP increases or decreases its data transmission rate in accordance with the congestion indication field in the ACK packet.

19. The method of claim 18 wherein the path includes at least one intermediate MP between the source MP and the destination MP.

20. The method of claim 19 wherein the intermediate MP forwards the data packet to another intermediate MP or the destination MP after updating the congestion indication field of the data packet based on whether or not the intermediate MP that forwarded the data packet is experiencing congestion.

21. The method of claim 20 wherein the ACK packet is an end-to-end packet sent from the destination MP to the source MP, and the destination MP generates the ACK packet based on the data packet with a congestion indication field that is updated by an intermediate MP in the path.

22. The method of claim 21 wherein the ACK packet is sent back to the source MP via the same path through which the data packet is forwarded to the destination MP.

23. The method of claim 21 wherein the ACK packet is sent back to the source MP via a path different than the path that the data packet is forwarded to the destination MP.

24. The method of claim 20 wherein the data packet further includes a quality of service (QoS) field indicating QoS parameters for the data flow, whereby each MP on the path determines the congestion indication by considering the QoS parameters.

25. The method of claim 18 wherein the data packet is a request-to-send (RTS) packet and the ACK packet is a clear-to-send (CTS) packet.

26. The method of claim 25 wherein the RTS packet is sent when a new data flow is initiated.

27. The method of claim 25 wherein the RTS packet is sent when the data flow is changed.

28. The method of claim 25 wherein the RTS packet is sent periodically to update the source MP with the available data rate.

29. The method of claim 25 wherein the RTS packet is sent when the source MP wants to change the data rate.

30. The method of claim 18 wherein the wireless mesh network is a mesh wireless local area network (WLAN).

31. In a wireless mesh network, a plurality of mesh points (MPs) supporting data flow control in the mesh network, each of the MPs comprising:
(a) an antenna for transmitting data and acknowledgement (ACK) packets; and
(b) a medium access control (MAC) entity for generating the transmitted data and ACK packets, each of the data and ACK packets including a flow identification (ID) field and an available data rate field, the available data rate field indicating an available data rate for a data flow identified by the flow ID field.

32. In a wireless mesh network, a plurality of mesh points (MPs) for supporting data flow control in the mesh network, each of the MPs comprising:
(a) an antenna for transmitting data and acknowledgement (ACK) packets; and
(b) a medium access control (MAC) entity for generating the transmitted data and ACK packets, each of the data and ACK packets including a flow identification (ID) field and a congestion indication field, the congestion indication field indicating that congestion exists at the MP.

33. In a wireless mesh network, a plurality of mesh points (MPs) for supporting data flow control in the mesh network, each of the MPs comprising:
(a) an antenna for transmitting data and acknowledgement (ACK) packets; and
(b) a medium access control (MAC) entity for generating the transmitted data and ACK packets, each of the data and ACK packets including a flow identification (ID) field and a quality of service (QoS) field, the QoS field indicating QoS parameters for the data flow.

34. In a wireless mesh network, a plurality of mesh points (MPs) supporting data flow control in the mesh network, each of the MPs comprising:
(a) an antenna for receiving a data packet including a flow identification (ID) field and an available data rate field;
(b) a data flow controller for updating the available data rate field based on an available data rate at the MP, the available data rate field indicating an available data rate for a data flow identified by the flow ID field; and
(c) a medium access control (MAC) entity for transmitting a data packet with the updated available data rate field via the antenna.

35. In a wireless mesh network, a plurality of mesh points (MPs) supporting data flow control in the mesh network, each of the MPs comprising:
(a) an antenna for receiving a data packet including a flow identification (ID) field and a congestion indication field, the congestion indication field indicating that congestion exists at the MP;
(b) a data flow controller for updating the congestion indication field to indicate that congestion exists at the MP; and
(c) a medium access control (MAC) entity for transmitting a data packet with the updated congestion indication field via the antenna.

36. In a wireless mesh network, a plurality of mesh points (MPs) supporting data flow control in the mesh network, each of the MPs comprising:
(a) an antenna for receiving a data packet including a flow identification (ID) field and a congestion indicator field;
(b) a data flow controller for increasing or decreasing the data transmission rate of the MP in accordance with the congestion indication field.

37. In a wireless mesh network, a plurality of mesh points (MPs) supporting data flow control in the mesh network, each of the MPs comprising:
(a) an antenna for receiving a data packet including a flow identification (ID) field and a quality of service (QoS) field, the QoS field identifying an access class of the data flow or other QoS parameters; and
(b) a data flow controller for reducing the data rate for data flows with a lower priority access class to accommodate higher access class flows.
